(19) United States
(12) Patent Application Publication
(10) Pub. No.: US 2021/0354567 A1
(43) Pub. Date: Nov. 18, 2021

(54) ELECTRIC VEHICLE

(71) Applicants: Rakesh Khatokar AMARNATH, Mysuru (IN); Srikanthan Bilijagalimole SREENIVASAMURTHY, Mysuru (IN); Ashwini Kumar KRISHNASWAMY PRATIWADIBHAYANKARAM, Bangalore (IN); Krishna GOPAL, Mysore (IN)

(72) Inventors: Rakesh Khatokar AMARNATH, Mysuru (IN); Srikanthan Bilijagalimole SREENIVASAMURTHY, Mysuru (IN); Ashwini Kumar KRISHNASWAMY PRATIWADIBHAYANKARAM, Bangalore (IN); Krishna GOPAL, Mysore (IN)

(21) Appl. No.: 16/479,613

(22) PCT Filed: Jan. 24, 2018
(86) PCT No.: PCT/IN2018/050039

§ 371 Date: Jul. 22, 2019

(30) Foreign Application Priority Data
Jan. 25, 2017 (IN) 201741002864
Oct. 30, 2017 (IN) 201743038381
Nov. 9, 2017 (IN) PCT/IN2017/050517

(51) Int. Cl. B60L 8/00; B60L 53/52; B60K 1/02; B60K 35/00; F03D 9/32; B01D 46/00; B01D 46/44

(52) U.S. Cl. CPC B60L 8/006; B60L 53/52; B60K 1/02; B60K 35/00; F03D 9/32; B01D 2279/40; B01D 46/446; B60K 2370/332; B60K 2370/16; F05B 2220/602; F05B 2240/941; B01D 46/0086

(57) ABSTRACT

Wind powered electric vehicle is disclosed. The invention specifically uses bleeding high velocity air due to motion of vehicles by means venturi inlets V1 V2 and directing it through venturi pipes (4) to drive an impeller/generator combination (1). to generate either variable AC power or DC power which is processed to generate regulated power. The power so generated being used to charge batteries which in turn feed energy to drive set of motors M1, M2 and optionally an auxiliary stand by motor (3). The number of venrturi inlets may be increased as per the size of vehicle which may have more than one pair of rear motors M2.

### FIELD OF INVENTION

The present invention provides wind powered electric vehicle. Particularly the invention provides a totally petroleum fuel free vehicle

### BACKGROUND OF INVENTION

Road and rail transport have been using petroleum fuels for powering engines for moving vehicles, cars, buses, heavy duty tracks, rail cars hauled by locos. All these have been using petrol or diesel for kinetic motion. There are buses using overhead electric power transmission with couplers drawing power for motion, electric locos similarly draw power from overhead lines. Diesel and petrol power engines draw power from batteries for ignition in the combustion engines for motion. There are electric cars and buses which use electric power to create kinetic energy for motion. In case of electric powered vehicles there is a need to recharge batteries frequently as continuous power drawn for motion depletes the energy stored. There is therefore a need to provide a system to a vehicle which will not require frequent recharging but instead continues to get charged by motion and also allows the vehicle to be in motion continuously. This is possible by installing a wind power assembly which generates power to maintain the energy in batteries while batteries continue to power the motors to get kinetic motion.

### OBJECTIVES Principal objective of the present invention is to provide wind powered electric vehicle.

An objective of the invention is to provide electric vehicle with two, three, four, six, ten wheels vehicle

An objective of the present invention is to provide an electric vehicle driven by electric motors.

Another objective of the invention is to provide batteries for driving electric motors.

Another objective of the invention is to provide a wind power assembly for charging the batteries

Another objective of the invention is to provide continuous charging of the batteries during continuous motion.

Still another objective is to cut down the fuel cost incurred and reduce the pollution level.

### DESCRIPTION OF THE DRAWINGS

FIG. 1 shows an embodiment of the wind powered electric vehicle wherein

(1) is Generator and battery system (2) is Front and Rear wheel axle, (3) is Supplementary backup motor (4) is set of Venturi tubes, (V1,V2) are Air filter with Sensor, (W1) are Front wheels, (W2) are Rear wheels (M1)Front wheel motors (M2)Rear end wheels Motors (31), (33), (34) and (35) form Chassis of the vehicle

FIG. 2 shows an embodiment of the wind power system wherein (101) is the Venturi Inlet (102) is the enclosure housing an impeller (103) and generator (104)

FIG. 3 shows the status of the filter. (a) shows clean filter, (b) shows 40%clogged at line (40) and (c) shows 75% clogging with line (75)

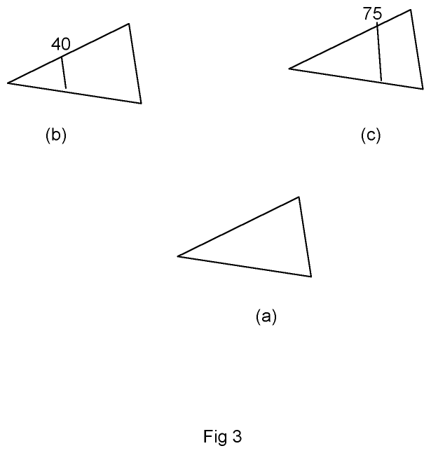

FIG. 4 shows an exemplary configuration of output to a bridge rectifies and then to a battery. (25) is the venturi inlet 1, (26) is the venturi inlet 3, (27) is the generator 1, (28) is the generator 2, (29) is the venturi inlet 2, (30) is the venturi inlet 4, (31) is the battery and (32) is the rectifier

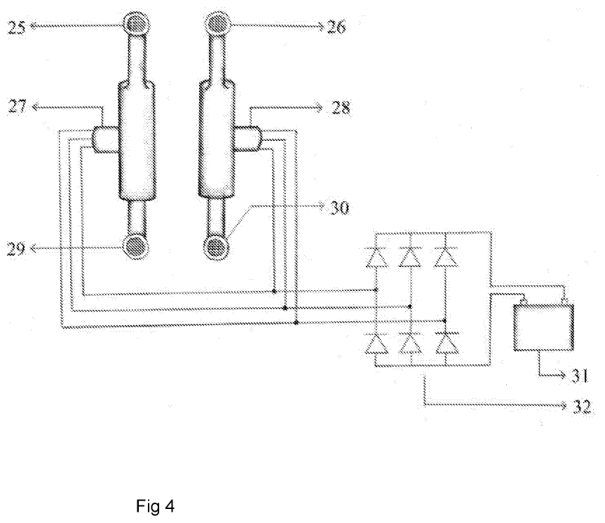

### SUMMARY OF INVENTION

According to main aspect of the invention there is provided wind poweredelectric vehicle comprising, vehicle chassis (31), (33), (34) (35), plurality of venturi inletsthrough plurality of venture pipes (4), the said veturi pipes comprising dust filters with sensors (V1) (V2) capable of filtering sucked air, the said sensors providing information of status of filters on a display, pressure of air, the said filtered air from venturi inlets being directed to impeller, generator, power electrical module (1), the said module comprising, AC to DC rectifier providing DC power to rechargeable battery bank, the said DC power from battery bank being transmitted to DC motors (M1) M2) attached to rear and front wheels providing motion to the vehicle.

According to an embodiment of the invention wherein the Venturi pipes are of lightweight bio degradable composite

J2 According to an embodiment of the invention wherein the impeller are of lightweight bio degradable composite.

According to another embodiment of the invention wherein the air filter is a HEPA filter

According to yet another embodiment wherein the sensor is a strain gauge sensor, a piezoelectric sensor.

According to yet another embodiment of the invention wherein the display is an LCD screen, LED screen.

According to yet another embodiment other invention wherein the information status of filters is in the form of triangular bar

### DETAILED DESCRIPTION

The description of this disclosure has reference to the pending applications 201741002864 on “wind power generation system for rail coaches”, 201743038381 on “wind power generation system for automobiles” and PCT/IN2017050517 on “wind power generation system for surface transport”

A system as disclosed in the present invention has been evolved for generating electricity by harnessing the wind energy in motion, caused by the motion of automobile. This wind is channelized through a venturi to directly fall on the impeller which is fixed to the shaft of the alternator. Thus, kinetic energy of the wind gets converted into mechanical energy, which in turn drives the generator to generate electricity. The temperature rise because of the magnetic field interaction occurring in the metal portion of the impeller is within the tolerable limits due to the circulation of the air.

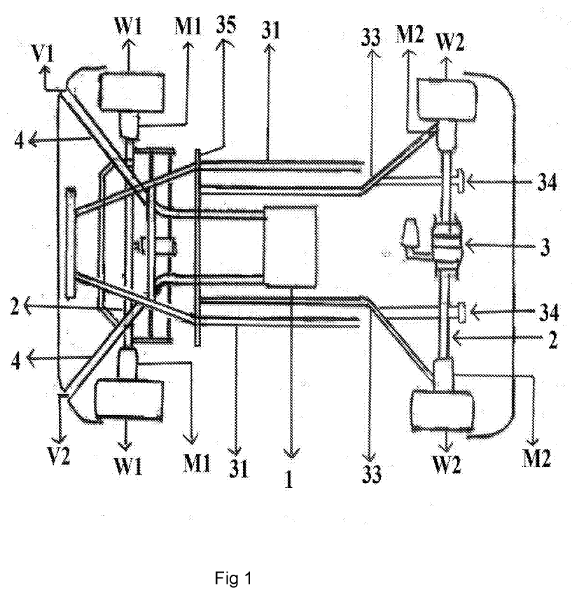

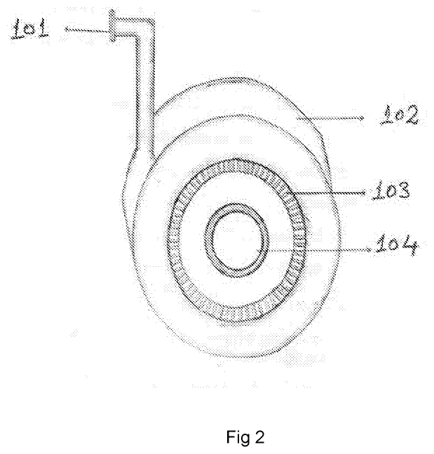

In a preferred embodiment, the inventions described in derails with reference to FIG. 1 without any limitations in working of the system by changing the parameters/specifications of the parts described therein. The Wind coming from opposite direction of motion of the automobile is allowed through the venturi inlets V1 V2 fixed at specified points. As an exemplary embodiment the number of Venturi are shown just two. The number may be more than two, depending on the size of a vehicle. For example, typically a vehicle of the size of a passenger bus having two front wheels and set of four rear wheels may preferably have six venturi pipes. Likewise a heavy duty truck with a set of eight rear wheels and two front wheels will need more air intake to drive the wind power generation for more power for feeding to the batteries and driving heavier duty motor. The inlets V1 and V2 are provided with air filters/sensor arrangements. The filters are necessarily to be provided to prevent dust particles entering the impeller/generator system. The filter may be a HEPA filter and the sensors may be a strain gauge sensor a piezoelectric sensor. The air getting directed to the impeller/generator assembly will be reduced in pressure when the filter gets clogged gradually by dust particles in the air sucked in during the motion of a vehicle. This reduction in pressure therefore affects the power generation. The state of the filters is displayed on a screen by means if triangular bar as shown in FIG. 2(a,b,c). A clear bar (FIG. 2a) indicating that the filters are clear while a partially filled bar (FIG. 2(b) 2(c) indicating that filters are clogged. The venturi pipes may be in a preferred embodiment of reinforced composite from waste materials as disclosed in U.S. Pat. No. 2,896,90 a patent granted to DEVARAJAN, CHANDRAMOHAN et al. The outlets of the venturi are brought to merge at a common point so as to channelize the wind received for driving the impeller of the turbine with a required force. The impeller used in this design is made up of either alloy of aluminum or steel which has high mechanical strength, light in weight and is balanced so as not to get deformed due to high wind velocity. In a preferred embodiment the impeller arrangement disclosed can be fabricated by replacing the metallic impeller to that of reinforced composite from waste materials thereby reducing the weight and improving the efficiency further. The number of blades may vary from 36 to 42 depending upon the wind pressure and velocity. The size of the impeller varies from 20 inches to 30 inches in diameter depending upon the wind pressure, type of the automobile and velocity to meet the electrical requirements. The turbine-shaft-generator arrangement fixed in such a way that, the alternator is embedded inside the impeller so as to reduce the space and coolant required to cool the generator. This arrangements housed in appropriate place in the automobile. The impeller forms the part of the turbine arrangement, so as to cause rotation by converting the kinetic energy of the wind to mechanical energy. The mechanical energy is then transmitted to the generator by means of shaft arrangement to which the generator is coupled, to generate ac or dc power output depending upon the type of battery. In case of AC, the generated power is fed to the bridge rectifier to get variable dc output. The ripples and the harmonics of dc output are smoothened by means of filter circuit arrangement incorporated in the bridge rectifier circuitry arrangement. The smoothened variable dc output from the rectifier is then regulated by means of voltage and current control circuitry arrangement so as to get constant dc output. The constant dc output is then used for battery charging. One more tapping is taken out to connect to the digital display unit to indicate battery status, output voltage and output current. The electrical power stored in the battery bank is transmitted to the motors M1 M2 attached d to the front and rear wheels. The number of motors to the rear wheels may be configured as per the number of wheels. The system of the present invention may be implemented without any limitation to any type of vehicle with two, here four wheels. The system works for such vehicles (heavy duty) which have plurality of rear wheel combinations as for example plurality of pair of adjacent wheels. As an additional feature towards ensuring increased reliability there is provided an additional motor ((3) in FIG. 1) of similar ratings as M1,M2, placed on the shaft connecting the two motors which are housed on the rear wheels of the automobile. This is provided to overcome the event of failure or non-functioning of any of the motors. However, in case both motors fail to perform, the automobile can be hauled to a secured location for attending the failure.

This additional motor comes useful while the automobile has to do the uphill task in case of terrains involving peaks and valleys.

Speed control of the vehicle is achieved by varying the parameters like current or voltage at the motors, appropriately to the required level as done in the present existing battery operated electric vehicles. This is achieved because speed is inversely proportional to current and directly proportional to voltage. Reverse movement of the vehicle is achieved by incorporating an electronic circuit like a H bridge or a changeover switch which reverses the direction of the current flow to the motor.

For increased power generation in the case of heavyduty vehicles, the number of venturies-impeller-generator sets can be increased depending upon the electrical requirements by placing it at appropriate positions whose working principle is same to that mentioned above in the invention. These additional venturies are placed at appropriate places such that it will not alter the center of gravity of the automobiles

In a preferred embodiment the high pressured filtered wind is allowed to pass in a controlled manner to pass through the air duct fitted in the automobiles there by reducing the effects of outside temperature on the cabin temperature. Thus there is a drastic reduction in the intensity of the quantum of temperature prevailing in the automobile which in turn reduces the pressure on compressor to keep the automobile cool hence there will be less frequency in replacement of the coolants

1. Wind powered electric vehicle comprising, vehicle chassis (31), (33), (34) (35), plurality of venturi inlets through plurality of venture pipes (4), the said veturi pipes comprising dust filters with sensors (V1) (V2) capable of filtering sucked air, the said sensors providing information of status of filters on a display, pressure of air, the said filtered air from venturi inlets being directed to impeller, generator, power electrical module (1), the said module comprising, AC to DC rectifier providing DC power to rechargeable battery bank, the said DC power from battery bank being transmitted to DC motors (M1), M2), (3) attached to rear and front wheels providing motion to the vehicle.

2. Wind powered electric vehicle as claimed in claim 1 wherein, the Venturi pipes are of lightweight bio degradable composite.

3. Wind powered electric vehicle as claimed in claim 1 where in the impeller is of light weight bio degradable composite.

4. Wind powered electric vehicle as claimed in claim 1 wherein, the air filter is a HEPA filter.

5. Wind powered electric vehicle as claimed in claim 1 wherein, the sensor is a strain gauge sensor, a piezoelectric sensor.

6. Wind powered electric vehicle as claimed in claim 1 wherein the display is an LCD screen, LED screen.

7. Wind powered electric vehicle as claimed in claim 1 wherein, the information status of filters is in the form of triangular bar.

8. Wind powered electric vehicle as claimed in claim 1 wherein, the vehicle moves over rough terrain.
